(19) United States
(12) Patent Application Publication
(10) Pub. No.: US 2019/0254482 A1
(43) Pub. Date: Aug. 22, 2019

(54) GRATING DEVICE

(71) Applicant: Mystic Apparel LLC, New York, NY (US)

(72) Inventors: Wilson Chow, New York, NY (US); Amanda Kono, New York, NY (US)

(21) Appl. No.: 15/901,499

(22) Filed: Feb. 21, 2018

(51) Int. Cl. A47J 43/25

(52) U.S. Cl. CPC A47J 43/25

(57) ABSTRACT

A grating device comprises a looped wire frame elongated in a longitudinal direction, the wireframe including first and second spaced parallel wires oriented in the longitudinally and a cross-bar that couples ends of the first and second parallel wires, a first grating surface coupled to the first and second parallel wires on a first side of the wire frame, the first grating surface having an array of blades of a first size, a second grating surface coupled to the first and second parallel wires on a second side of the wire frame, the second grating surface having an array of blades of a second size, different from the first size, a handle coupled to the wire frame, and a non-slip foot rotatably coupled to the cross-bar of the wire frame, the non-slip foot having at least one planar surface that provides frictional contact with an external working surface.

### FIELD OF THE INVENTION

The present invention relates to kitchen appliances and in particular relates to a grating device.

### BACKGROUND OF THE INVENTION

Hand-held grating devices for grating cheese, onions, celery, etc. are common kitchen appliances. However, grating devices typically have a single blade size and lack flexibility. While designs have been proposed that incorporate multiple blade sizes in a in single device, these designs are not optimally designed for manual flexibility. For example, U.S. Design Pat. No. 759,436 ('D436) discloses a grating device having different blade sizes on opposite sides of the device. However, 'D436 is an enclosed device and lacks a mechanism to secure the grater on a platform at a desired cutting angle so that the device can be used on a variety of objects of various sizes and in different positions.

What is therefore needed is a convenient grating device that can be used flexibly for fine or coarse grating and has improved manual flexibility.

### SUMMARY OF THE INVENTION

Embodiments of the present invention provide a grating device that comprises a wire frame formed in a loop and elongated in a longitudinal direction, the wireframe including first and second parallel wires oriented in the longitudinal direction spaced apart by a width and a cross-bar that couples ends of the first and second parallel wires, a first grating surface coupled to the first and second parallel wires on a first side of the wire frame, the first grating surface having an array of blades of a first size, a second grating surface coupled to the first and second parallel wires on a second side of the wire frame, the second grating surface having an array of blades of a second size, different from the first size, a handle coupled to the wire frame, and a non-slip foot rotatably coupled to the cross-bar of the wire frame, the non-slip foot having at least one planar surface that provides frictional contact with an external working surface. In some implementations, the non-slip foot has a triangular cross-sectional shape.

In certain embodiments, the first and second grating surfaces have top and bottom edges that extend between the first and second parallel wires of the wire frame, and the cross bar is positioned above the top edges of the first and second grating surfaces by a clearance distance sufficient to enable removal of grated food pieces from the grating device. In some embodiments, The first and second parallel wires extend beyond the bottom edges of the first and second grating surfaces and converge inwardly toward the handle, and there is a clearance space between the bottom edges of the first and second grating surfaces and the handle sufficient to allow a cleaning fluid to be flushed between the first and second grating surfaces.

In some implementations, the clearance distance sufficient to enable removal of grated food pieces from the grating device can range from about 1.0 to about 2.5 inches. Additionally, in some implementations, the clearance space between the bottom edges of the first and second grating surfaces and the handle ranges from about 0.6 to 1.2 inches.

The first grating surface can be welded to at least one of the first and second parallel wires on the first side of the wire frame, and the second grating surface can be welded to at least of the first and second parallel wires on the second side of the wire frame.

The wire frame can be implemented using two wires coupled together and formed in a loop. In such implementations, the non-slip foot is rotatably coupled around both of the two wires at the crossbar of the wire frame.

In some ergonomic embodiments, the first and second grating surfaces have a length in the longitudinal direction ranging from about 5.0 to about 10.0 inches. The first and second grating surface can have a width ranging from about 1.0 to about 3.0 inches. The internal space between the first and second grating surfaces can range from about 0.7 to about 1.3 inches.

One of the useful characteristics of the grating devices according to the present invention is that when a planar surface of the non-slip foot is placed at a position on the external working surface, an angle of the grating surfaces with respect to the working surface is adjustable while the non-slip foot maintains the position on the working surface.

In some implementations, the grating device of claim 1, wherein the blades in the array of blades of the first grating surface range in width from about 1 to about 2 mm. The blades in the array of blades of the second grating surface can range in width from about 3 to about 8 mm.

### BRIEF DESCRIPTION OF THE DRAWINGS

FIG. 1 is a front plant view of a grating device according to an exemplary embodiment of the present invention.

FIG. 2 is a side view of the grating device according to an exemplary embodiment of the present invention.

FIG. 3 is a top perspective view of a grating device according to an exemplary embodiment of the present invention.

FIG. 4 is a top perspective view of another embodiment of a grating device according to the present invention.

FIG. 5 is a front plan view of another embodiment of a grating device according to the present invention.

FIG. 6A is schematic illustration showing a grating device according to the present invention oriented at a first angle with respect to an item to be grated.

FIG. 6B is a schematic illustration showing a grating device according to the present invention oriented at different angle from that shown in FIG. 6A.

### DETAILED DESCRIPTION CERTAIN OF EMBODIMENTS OF THE INVENTION

This disclosure concerns a handheld apparatus for grating, referred to herein as a “grating device”, that improves on current designs by providing different-sized blades on opposite sides, a frame design that facilitates convenient cleaning, openings to allow food to fall through the device without accumulating, and a non-slip foot feature that enables the grating device to be handled at any angle with respect to a surface without slipping, thereby providing greater manual leverage to be applied for efficient grating.

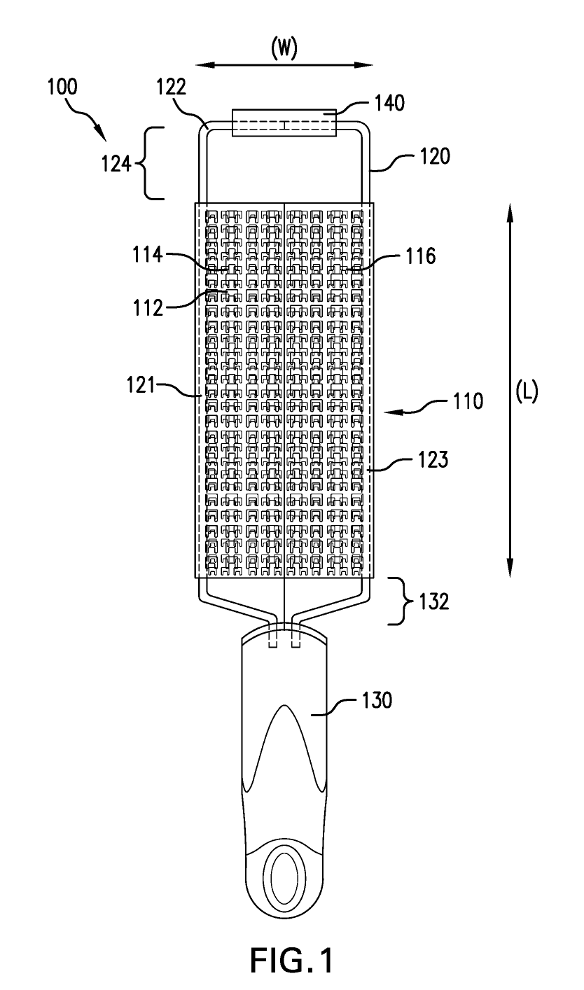

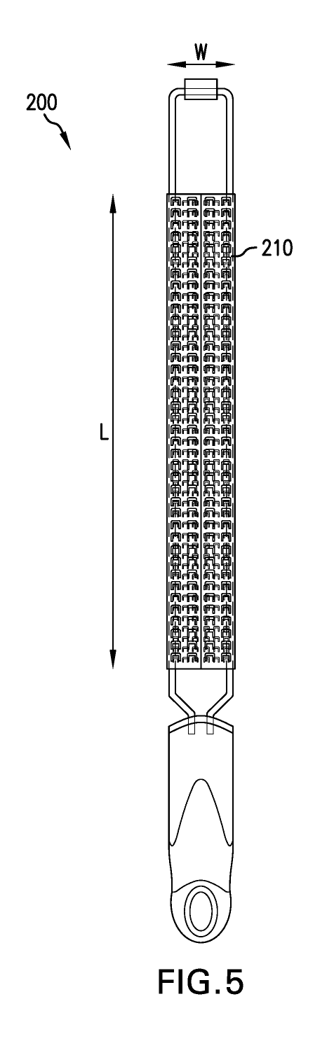

FIG. 1 is a front view of a first side of a handheld grating device 100 according to an exemplary embodiment of the present invention. Grating device 100 includes a generally elongate first grating surface 110 having a first array of blades e.g., 112, 114, 116. The blades, e.g., 112, 114, 116 are arranged in rows and columns that cover a substantial majority of the grating surface. The grating surface 110 is elongated in a longitudinal dimension (L), along which the grating device is intended to be moved during a grating motion, in comparison to its lateral dimension or width (W). In some embodiments, the longitudinal length of the grating surface can range from about 5.0 inches to about 10.0 inches, and the width dimension can range from about 1.0 to 3.0 inches, but other dimensions can also be used. In the embodiment depicted in FIG. 1, the grating surface 110 has a length/width ratio of approximately 2.2:1. However, grating surfaces used in the grating devices of the present invention can have a wide range of relative dimensions. For example, FIG. 5 illustrates another embodiment of a grating device 200 according to the present invention having different grating surface dimensions. In the embodiment of FIG. 5, the grating surface 210 has a length/width ratio of approximately 7:1 and is elongated and shaped like a file. In general, it should be appreciated that the dimensions of a particular grating device depend upon particular applications and user preferences.

Referring again to FIG. 1, in the embodiment depicted, the blades of the first array 112, 114, 116 are planar and rectangular in shape, and are slightly angled with respect to the surface for cutting or abrading. However, the blades can have other shapes, for example, triangular. The grating surface 110 can be made of a lightweight metal such as aluminum or stainless steel that has sufficient durability to maintain the sharpness of the blades.

The lateral edges of the grating surface 110 are coupled to a wire frame 120, for example by welding. The wire frame 120 is shaped in the form of a generally rectangular loop. The wire frame 120 comprises parallel wires 121, 123 (referred to as herein “runners”) which extend in along and beyond the lateral edges of the grating surface, and a crossbar 122 that joins the lateral runners beyond the top edge of the grating surface. The wire frame 120 also extends beyond the bottom edge of the grating surface 110 where the lateral runners bend inwardly and terminate fixedly in a handle 130. The handle 130 can be ergonomically shaped and size for manual gripping and can made from any suitable material for providing a firm grip such as rubber or plastic.

The design of the wire frame 120 according to the present invention provides spaces to provide for convenient cleaning and food removal. For example, there is a clearance space 124 located between the crossbar 122 and the top edge of the grating surface 110 in which grated food can fall out from the grating device. In some embodiments, the clearance space 124 can range from about 1.0 to about 2.5 inches long in longitudinal direction. Additionally, embodiments of the grating device 100 include a clearance space 132 located in the section bounded by the bottom edge of the grating surface, the handle, and the converging arms of the wire frame. Clearance space 132 is sufficient to allow water to be flushed into the grating device to clean the device and remove any grated food that adheres to the blades. In some embodiments, clearance space 132 can range from about 0.6 to 1.2 inches in the longitudinal direction.

A non-slip foot 140 is rotatably coupled to the crossbar 122. The non-slip foot 140 is adapted to be rest flat on a working platform on which food items are placed so as to provide a stable fulcrum for manual handling of the grating device. In some embodiments, non-slip foot 140 has a triangular cross-section with planar sections and therefore is able to self-align on a flat surface. The foot 140 can be made from a material having a high friction coefficient with respect to common kitchen surfaces such as rubber or certain plastics. The high friction coefficient ensures that the grating device does not slip when force is applied to the grating device for grating. Non-slip foot 140 is rotatable around the axis of the crossbar 122, allowing the “working” or “grating” angle between the longitudinal axis of the grating device and the surface (not shown) upon which the non-slip foot 140 is placed to be adjusted. The angle can be adjusted according to the size and shape of food items to be grated, for example.

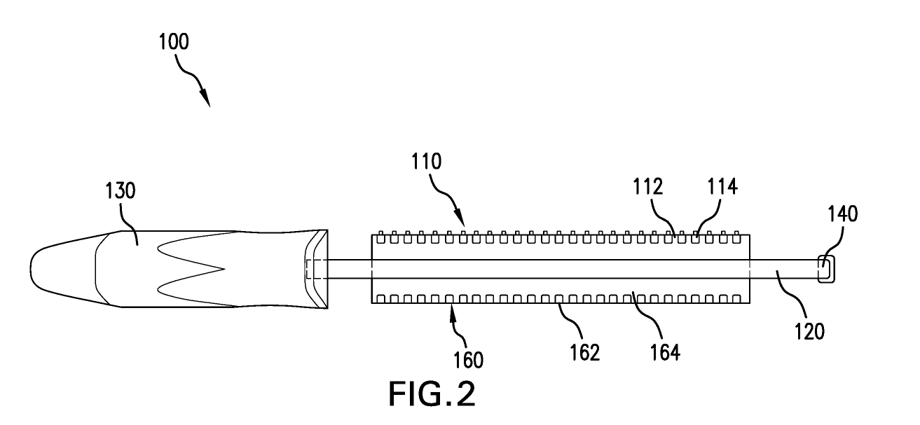

The reverse side of the grating device, not shown in FIG. 1, includes a second grating surface with another array of blades which have different widths from the blades of the first grating surface. FIG. 2 is a side view of the embodiment of the grating device according to the present invention shown in FIG. 1 and shows second grating surface 160 positioned opposite from the first grating surface 110 across wire frame 120. The sizes of the blades on the respective grating surfaces are different, providing the device with the flexibility to grate food items differently using the same device. In the exemplary grating device shown in FIG. 2, the first grating surface includes blades, e.g., 112, 114 that are smaller in size and produce more finely grated pieces, while the blades of the second surface, e.g., 162, 164 are larger in size and produce more coarsely grated pieces. In an exemplary embodiment, the smaller blades of grating surface 110 can range from 1 mm to about 2 mm, and the larger blades of grating surface 160 can range from about 3 mm to about 8 mm.

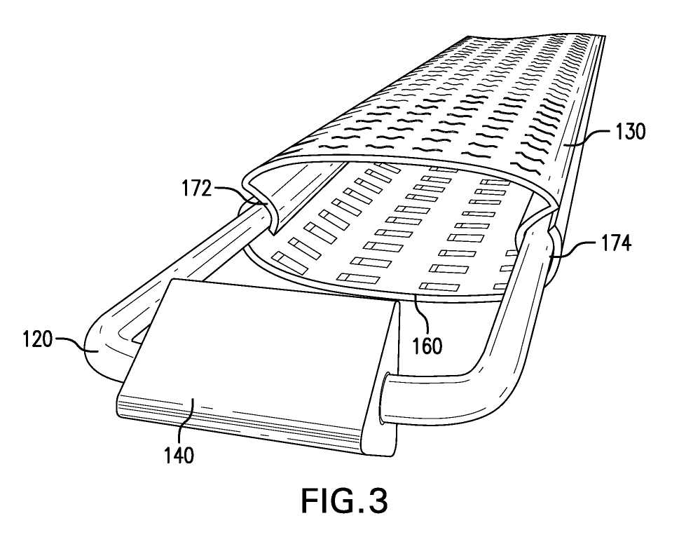

FIG. 3 is a top perspective view of an embodiment of a grating device according to the present invention. The view of FIG. 3 depicts the internal space within the grating device, between the first grating surface 110 and the second grating surface 160. In some embodiments, the maximal distance between the first and second grating surfaces 110, 160 is in a range from about 0.7 inches to about 1.3 inches, although the grating can be designed with larger inter-surface distances. In the embodiment depicted in FIG. 3, the lateral edges of first grating surface 110 are bent downwardly and toward the inner side of wire frame 120. The downwardly bent portion of grating surface 110 is securely coupled to the wire frame 120 by a welded junction 172. Lateral edges of second grating surface 160 are bent upwardly toward the outer side of wire frame 120. The upwardly bent portion of second grating surface 160 is securely coupled to the wire frame 120 by a further welded junction 174. While welding is one useful technique for securing grating surfaces to the wire frame, other techniques can be used, for example, the grating surface can be fixed to the wire frame by detents, snap fit connections, grooves, etc.

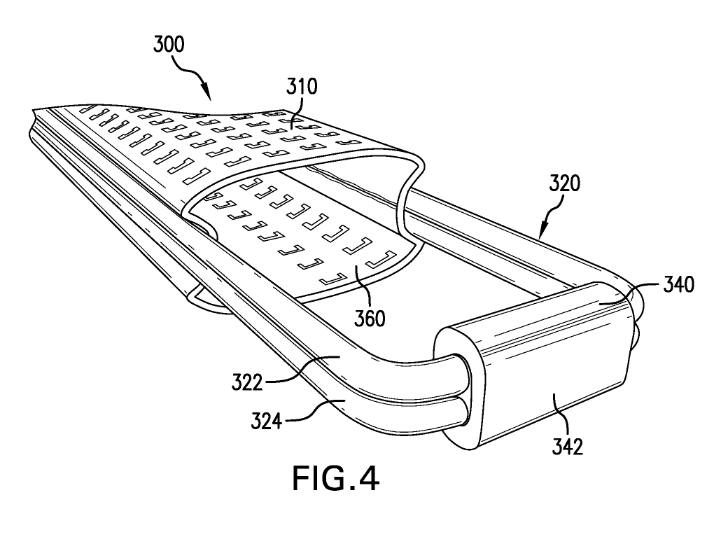

FIG. 4 is a top perspective view of another embodiment of a grating device 300 according to the present invention. Grating device 300 includes grating surfaces 310, 360 and a doubled wire frame loop 320 comprising two adjacent wires 322, 324. A non-slip foot 340 is positioned over both wires 322, 324. In the embodiment of FIG. 4, non-slip foot 340 is largely oval in shape and includes planar sections e.g., 342 having an expanded surface area. The additional surface area of non-slip foot 340 can provide additional surface friction to prevent slippage. Due to the additional width of the double wire frame 320, the distance between the grating surfaces 310, 360 is larger than in the embodiment shown in FIG. 3, which can be a desired feature for some applications.

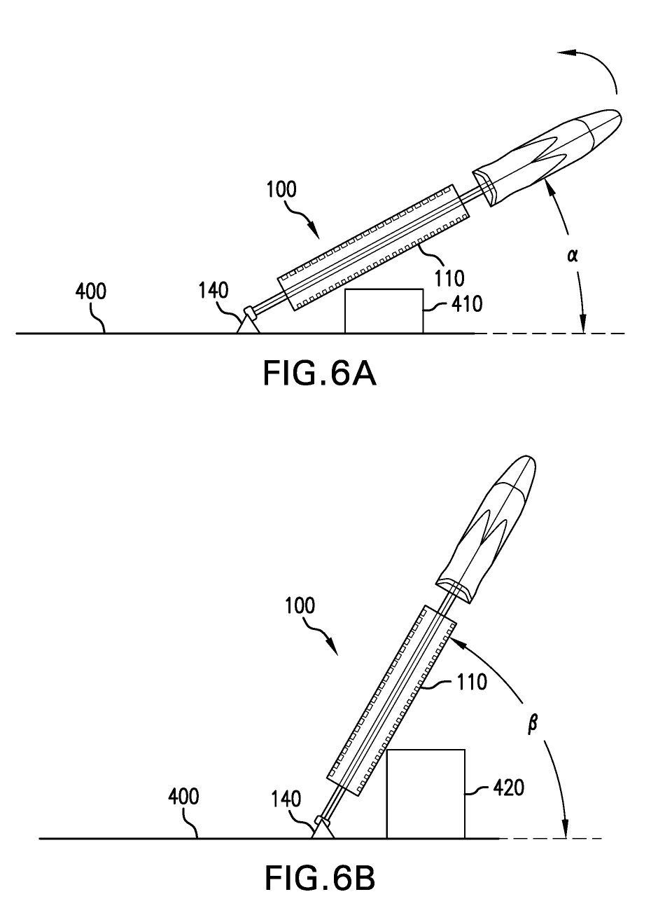

In FIG. 6A, an exemplary use of the grating device to grate a food item is schematically illustrated. A shown, grating device 100 is oriented with respect to a working surface 400 so as to grate a food item 410 with grating surface 110 at a first angle α. Non-slip foot 140 of the grating device is aligned with a planar surface parallel to surface 400 to prevent slippage. FIG. 6B illustrates a shift in orientation of the grating device from the orientation shown in FIG. 1. In FIG. 6B, grating device is oriented with respect to working surface 400 so as to grate a second food item 420 with grating surface 110 at a second angle β, greater than the first angle α. It is noted that while the orientation of the longitudinal axis of the grating device has changed, the orientation non-slip foot 140 has not changed, and the planar surface of the non-slip foot 140 maintains its parallel orientation with respect to working surface 400 to prevent slippage. In this manner, the grating device can be oriented at different angles in accordance with the size and shape of the food items to be grated or for ergonomic reasons, while maintaining the orientation of the non-slip foot for prevention of slippage, allowing the grating device to be used flexibly and efficiently.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A grating device comprising:
a wire frame formed in a loop and elongated in a longitudinal direction, the wireframe including first and second parallel wires oriented in the longitudinal direction spaced apart by a width, the parallel bars being coupled at distal ends by a cross-bar portion;
a first grating surface coupled to the first and second parallel wires on a first side of the wire frame, the first grating surface having an array of blades of a first size;
a second grating surface coupled to the first and second parallel wires on a second side of the wire frame, the second grating surface having an array of blades of a second size, different from the first size;
a handle coupled to the wire frame at proximal ends of the first and second parallel wires; and
a non-slip foot rotatably coupled to the cross-bar portion of the wire frame, the non-slip foot having at least one planar surface that provides frictional contact with an external working surface.

2. The grating device of claim 1, wherein the non-slip foot has a triangular, cross-sectional exterior shape.

3. The grating device of claim 1, wherein the first and second grating surfaces have top and bottom edges that extend between the first and second parallel wires of the wire frame, and wherein the cross bar portion is spaced from the top edges of the first and second grating surfaces by a clearance distance sufficient to enable removal of grated food pieces from the grating device.

4. The grating device of claim 3, wherein the first and second parallel wires extend beyond the bottom edges of the first and second grating surfaces and converge inwardly toward the handle, and wherein a clearance space between the bottom edges of the first and second grating surfaces and the handle is sufficient to allow a cleaning fluid to be flushed between the first and second grating surfaces.

5. The grating device of claim 1, wherein the first grating surface is welded to at least one of the first and second parallel wires on the first side of the wire frame, and wherein the second grating surface is welded to at least of the first and second parallel wires on the second side of the wire frame.

6. The grating device of claim 1, wherein the wire frame includes two wires coupled together and formed in a loop.

7. The grating device of claim 6, wherein the non-slip foot is rotatably coupled around both of the two wires at the crossbar of the wire frame.

8. The grating device of claim 1, wherein the first and second grating surfaces have a length in the longitudinal direction ranging from about 5.0 to about 10.0 inches.

9. The grating device of claim 1, wherein the first and second grating surface have a width ranging from about 1.0 to about 3.0 inches.

10. The grating device of claim 1, wherein when one of the at least one planar surfaces of the non-slip foot is placeable at a position on the external working surface, wherein an angle of the grating surfaces with respect to the working surface is adjustable while the non-slip foot maintains the position on the working surface.

11. The grating device of claim 1, wherein the blades in the array of blades of the first grating surface range in width from about 1 to about 2 mm.

12. The grating device of claim 1, wherein the blades in the array of blades of the second grating surface range in width from about 3 to about 8 mm.

13. The grating device of claim 1, wherein an internal space between the first and second grating surfaces ranges from about 0.7 to about 1.3 inches.

14. The grating surface of claim 3, wherein the clearance distance sufficient to enable removal of grated food pieces from the grating device ranges from about 1.0 to about 2.5 inches.

15. The grating surface of claim 4, wherein the clearance space between the bottom edges of the first and second grating surfaces and the handle ranges from about 0.6 to 1.2 inches.
